(19) United States
(12) Patent Application Publication
(10) Pub. No.: US 2014/0081432 A1
(43) Pub. Date: Mar. 20, 2014

(54) Method and Apparatus for Rehabilitation Using Adapted Video Games

(71) Applicants: Rhode Island Hospital, Providence, RI (US); Brown University, Providence, RI (US)

(72) Inventors: Angus Kingon, Warren, RI (US); John Donoghue, Providence, RI (US); Yi-Ning Wu, Warwick, RI (US); Karen Kerman, Providence, RI (US); Brian Monetti, Providence, RI (US)

(73) Assignees: Rhode Island Hospital, Providence, RI (US); Brown University, Providence, RI (US)

(21) Appl. No.: 14/024,846

(22) Filed: Sep. 12, 2013

Related U.S. Application Data
(60) Provisional application No. 61/700,258, filed on Sep. 12, 2012.

(51) Int. Cl. G05B 15/02

(52) U.S. Cl. CPC G05B 15/02
USPC 700/90

(57) ABSTRACT

A participant, engages in healthcare provider prescribed physical rehabilitation exercises utilizing specifically designed controllers, and these exercises are mapped to one or more video game commands. These commands are coupled with other inputs to control the video game that will be used to ensure adherence to a prescribed rehabilitation regimen. Information is gathered on the participant, in order to aid in rehabilitation.

### RELATED APPLICATION

This application claims the benefit of U.S. Provisional Application No. 61/700,258, filed on Sep. 12, 2012.

The entire teachings of the above application are incorporated herein by reference.

### FIELD OF INVENTION

The invention relates to physical rehabilitation systems, relating to the use of video games in rehabilitation.

### BACKGROUND OF THE INVENTION

Stroke and Cerebral Palsy, along with other brain injuries, affect the physical abilities of users, or participants. Physical rehabilitation is an effective means of therapy. Therapists use particular forms and patterns of movement for prescribed durations that promotes functional recovery. This entails the direct interaction with highly trained therapists and the use of expensive technology. Home therapy is prescribed to meet the objective of ongoing practice of the desired regimen. However, therapy in the clinical setting is expensive and not available to all of those who can benefit, and home compliance of therapy regimens is typically unmeasured and based on self-report. This may lead to variable or unreliable outcomes.

Rehabilitation therapy both improves the musculoskeletal system and, in ways that are not fully understood, can engage neural plasticity mechanisms in the brain that promotes and sustains functional recovery. To affect both musculoskeletal recovery and to engage neural plasticity, high intensity, repetitive and structured practice (termed massed practice) is required. However, this goal is rarely met in conventional therapy, because of compliance, cost, or availability reasons. At-home rehabilitation methods currently available can provide an opportunity for additional therapy, but these methods are generally monotonous and participants easily get bored, leading to ineffective therapy; they lack motivation to follow a meaningful massed practice exercise therapy routine. Participants who utilize at-home rehabilitation methods also lack the guidance from experts, which is necessary to ensure that proper methodologies, including timing and form of the proscribed regimen, are carried out in their therapy. To motivate participants to perform large amount of repetitive movement, video game technology (customized and commercial Virtual Reality or gaming consoles) has been brought into rehabilitation.

Most therapies are directed to whole body motor training such as balance or reaching. Less attention has been paid to rehabilitation of isolated joint/body parts (such as the forearm or wrist), despite the fact that people with brain injuries commonly experience difficulty controlling isolated movement, such as moving the wrist while the arm is held in a controlled and fixed posture when writing. In addition, many parties invest effort in designing rehabilitation games; and less consideration has been given to the adaptive controllers with proper motion register, which is essential to understand both the form and duration of the actions carried out when the game is played. Being able to play generic games with typically-developing or fully developed peers provides an important social opportunity; it is known that social engagement both increases motivation and promotes learning. (Madge S, Affleck J, Lowenbraun S., “Social effects of integrated classrooms and resource room/regular class placements on elementary students with learning disabilities,” J. Learn. Disabil. 1990 August-September; 23(7):439-45. PubMed PMID: 2398316, the relevant teachings of which are incorporated herein by reference in its entirety.)

Commercially available video games with external controllers (e.g. Nintendo's Wii® Sport and Wii® Fit) have been employed with mixed results. In particular these approaches are poor for specific motor training because, generally, they neither prevent undesired motions nor do they tightly constrain training movement. That is, game controllers allow users to achieve control of the feedback signal using any action actuates the controller sensors—this might include actions as different as moving left and right with wrist or using shoulder movement. Standard game controller setups are unable to differentiate these signals. Finally, game controllers for people with limited control of one body part restrict control so that only simple, unmotivating games can be controlled; playing generic games requires additional control dimensions while achieving the rehabilitation regimen. A system is needed which allows for effective at-home physical rehabilitation, involving structured massed-practice, while motivating participants, monitoring the form, pattern and extent their therapy and giving feedback in order to encourage maximum engagement in the therapy.

### SUMMARY OF THE INVENTION

The invention generally relates to a method and apparatus for therapeutically motivating a participant, lacking at least partial body or extremity motor control, to perform a prescribed exercise while also providing a means to track compliance, supervise use, and monitor functional recovery.

In one embodiment of the invention, the method includes prescribing an individual exercise program for the participant, that includes at least one of sensory stimulation, motor stimulation and motor facilitation, by manipulating at least one programmed response of an exercise controller. A signal generated by the exercise controller is sent to a video console and video monitor by way of a secondary processor in response to manipulation of the exercise controller by a first body part of the participant. To achieve multidimensional control, complementary signals generated by a complementary controller are sent to the video console by way of the secondary processor. It is to be understood that the exercise controller and the secondary processor can be controlled by the same processor, so long as there is an interface allowing use of both the exercise controller and the secondary processor.

The complementary signal is generated by manipulations of the complementary controller by the participant, using a second body part (i.e. not the one targeted for therapy). At least one programmed response of the exercise controller is modified consequent to a comparison of the signal generated by the exercise controller to a rehabilitation exercise prescription. A signal generated by the modified program response is sent from the secondary processor to at least one of an audio, visual proprioceptive, and tactile indicator that is linked to at least one of the video console and the secondary processor, thereby tailoring the signal of the exercise controller and, consequently, therapeutically motivating the participant.

In another embodiment of the invention, the apparatus includes an exercise controller that responds to therapeutic motions of at least one extremity of the participant. The apparatus also includes a video console, and at least one of an audio, visual and tactile indicator linked to the console. A secondary processor links the exercise controller and the video console, whereby the secondary processor can modify signals from the exercise controller so that a programmed response of the video console to the exercise controller can be modified in response to a comparison with a rehabilitation exercise prescription in an updating manner to motivate the participant, to employ therapeutic motions of the extremity to thereby obtain a desired response by the video console. A complementary controller is linked to the secondary processor that sends at least one signal that is complementary to the signal generated by the exercise controller.

The invention provides improved rehabilitation as a result of better participant motivation and the fact that rehabilitation is monitored and updated in response to participant activity in order to assure proper compliance in the pattern, form and duration of prescribed therapy regimens. For example, repetitive target joint movements conducted by the participant can be updated to promote musculoskeletal recovery or neural plasticity. Although utilized primarily by participants who have suffered brain injuries such as stroke and cerebral palsy, the invention can be employed to treat participants suffering from other injuries for which physical therapy regimens are used. The method and apparatus of the invention can also verify whether a participant, manipulates the Exercise Controller at the correct orientation, or temporal or usage pattern and provides feedback in the log-in dialog. For example, the apparatus of the invention can ask the participant to reverse the controller if she/he holds the controller upside down or uses the wrong hand.

### BRIEF DESCRIPTION OF THE DRAWINGS

FIG. 1 is a schematic representation of one embodiment of the apparatus of the invention.

FIG. 2 is an algorithm of one embodiment of a method of use of the apparatus of FIG. 1.

### DETAILED DESCRIPTION OF THE INVENTION

The invention includes, in one embodiment, a system that uses video games as a means for motivating participants and monitors the quality of their rehabilitation, at home, for example, by recording movement and providing feedback. The invention includes specifically designed video game controllers which are activated by the rehabilitation motions of the participant. These controllers are coupled with other participant-activated controllers, which are also specifically designed to meet their abilities and needs, and which, when combined with a converter, will allow for the full game play of a generic video game. The game can be either one that is custom-designed for rehabilitation purposes, or a preexisting video game system or a web-based video game via an internet connection. The invention also includes means and methods for: tailoring an on-line interactive game command or control signal by a therapist or healthcare provider in response to a participant's ability; monitoring participant, use of the system; monitoring and preventing improper movement by the participant; storing and transmitting information on the use of the system to a therapist; analyzing the data generated by use of the system and participant progress; giving feedback to participants consequent to, for example, quality of movement such as performance and sensation stimulation, including, for example, sound, light or vibration; and altering or adapting the prescription of rehabilitation to meet participant recovery needs, either by automatic adaptive algorithms or by technical oversight.

In one embodiment, the invention is a system that allows people with brain injuries and other injuries or physical shortcomings to engage in at-home rehabilitation exercises that are prescribed by a therapist or other health professional based on their capability and incorporated into controls for video games while other, unwanted movements, are monitored. The system consists of a set of video game controllers, one of which is an Exercise Controller, which is controlled by a therapist prescribed rehabilitation exercise, and the other is a Complementary Controller, which is utilized by the participant, which together allow for full game play.

In another embodiment, the invention is a method for monitoring the use of the system by the participant and storing and transmitting information relating to its use. The participant is also monitored for proper compliance with the rehabilitation exercises, which includes proper posture in order to ensure maximum compliance to the therapeutic regimen. Feedback is given on the use and compliance of the system in various forms. Optionally, participants can be passively reminded how much and how frequently they exercise by seeing a session performance summary chart each time they log in and log out. Also, optionally, participants can be actively reminded by an alarm, voice, video image or text message of the system of the invention.

The information that is collected on the participant is able to be stored and transmitted to health care professionals or technicians. This information can be used to track participant progress and compliance, and to, for example, update rehabilitation prescriptions, either automatically or manually by the therapist.

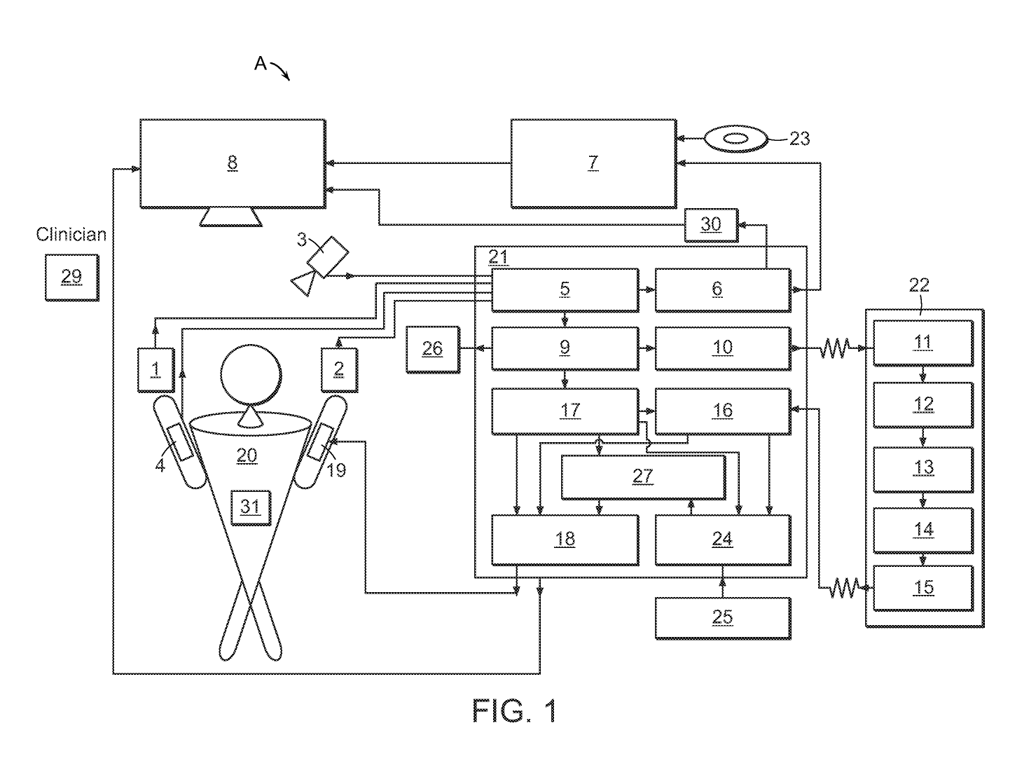

FIG. 1 depicts one embodiment of rehabilitation system A of the invention and its components. The use of system A by participant 20 is prescribed by a therapist or healthcare provider (29). The prescription includes use of Exercise Controller (1), a number of repetitions of use of the Exercise Controller (1) to be completed, and other information and mechanisms relevant to the rehabilitation needs of participant, 20. The Exercise Controller (1) for playing the video games, recording the movement, strength, muscle tone and providing therapeutic stimulation can be specially designed to fit a participant's hand.

In one embodiment, the Exercise Controller (1) is specially designed to accommodate a weak grip of a participant, and has a lightweight and egg-shape (or others) which fits naturally within a participant's palm. The Exercise Controller (1) contains a microprocessor and inertial measure unit which can sense the orientation of the limb or body part using the Exercise Controller (1). However, the Exercise Controller (1) can exist in various forms depending on the prescription.

The system can be used for prescribing the rehabilitation exercise by a healthcare provider (29) and be used to perform at-home rehabilitation by a participant (20).

A real-time human-machine interface algorithm is used to prescribe the rehabilitation exercise guided by a healthcare provider (29) according to each participant's capability. For example, a participant (20) will hold an Exercise Controller (1) and move in the direction (such as wrist flexion or extension) as instructed by a healthcare provider (29). The characteristics of each motion prescribed will be captured by the sensors within an Exercise Controller (1), transmitted to the Signal Interpreter (5) and stored in the Data Storage (9) within a Secondary Processor (21). The captured characteristics will be labeled as a rehabilitation exercise prescription by the Real-time Data Analyzer (17) and stored in the Prescription Information Storage (24).

The use of the system at home is initiated by the participant. (20). The system is set up in the manner of a standard video game system, however, it includes a secondary Processor (21) distinct from the Video Game System (7). The Processor (21) is connected as an input to the Video Game System (7), accepts inputs from an Exercise Controller (1), a Complementary Controller (2), one or more Cameras (3), a Sensor Package (4), has outputs to a Feedback Device (19), and a Monitor (8), has Local Prescription Input (25), and is also connected to the Remote Processor (22), for both the transmission and receiving of data and information. The prescription for the participant, is contained in the Prescription Information Storage (24), which is a component of the Processor (21). The prescription contained by the Prescription Information Storage is either updated locally, through the Local Prescription Input (25), or remotely. The prescription is viewed by the participant, on the Monitor (8), either prior to or during the use of the system. The prescription stored in the Prescription Information Storage (24), more specifically the motion characteristics of rehabilitation exercise, is used for converting the signal from the Exercise Controller (1).

To control the Video Game System (7), the participant, utilizes two distinct controllers, an Exercise Controller (1) and a Complementary Controller (2) or only an Exercise Controller (1). The Exercise Controller (1) is designed specifically to be utilized in a manor corresponding to the therapist prescribed rehabilitation regimen. The Exercise Controller (1) can exist in various forms depending on the prescription. An example would be an accelerometer based controller which is activated by pronation or supination of the participant's wrist, however many manifestations can exist, including combinations of sensors such as pressure, temperature, galvanic, inertial, gravitational, or 6 axis accelerometers that can evaluate the participants use and condition. The Exercise Controller (1) transmits a signal, either analog or digital, to the Signal Interpreter (5) upon activation by the rehabilitation exercise. The signal can be on one or multiple channels, which will correspond to distinct rehabilitation exercises. Along with the Exercise Controller (1), a Complementary Controller (2) is also utilized by the participant. The Complementary Controller (2) has the purpose of providing all necessary controls for game play, aside from the controls that are activated by the Exercise Controller (1). The Complementary Controller (2) is designed to meet the physical capabilities of the participant, which will vary depending on the participant's particular physical abilities. An example would be a single handed video game controller which would be utilized by the unaffected hand of a hemiplegic stroke participant, however many manifestations can exist where other body parts could be used to extend or modify control capabilities.

The activation signals of the Exercise Controller (1) and the Complementary Controller (2) are interpreted by the Signal Interpreter (5), which is a component of the Processor (21). These signals are converted into game control signals using the Controller Signal Converter (6). This converts the signals into the inputs for a generic Video Game System (7), which are then ported to the Video Game System (7). The Video Game System (7) can be one which is commercially available or one which is custom designed for rehabilitation purposes. The output of the Video Game System (7) is then viewed by the participant, on a Monitor (8). In this manor, the participant, is able to fully control the use of the Video Game (23) on the Video Game System (7) through the use of the Exercise Controller (1) and the Complementary Controller (2). Other embodiments could include auditory or tactile feedback of output when vision is limited.

In another embodiment, Secondary Processor (21) can be used as a stand-alone system without connecting to the Video Game System (7). The game-controlled signals converted by the Controller Signal Converter (6) can be ported to the Embedded Game System (30), which contains games installed in this secondary Processor (21) or links to the website games. The Embedded Game System (30) can be viewed by the participant, on a Monitor (8).

Along with the data from the Exercise Controller (1) and the Complementary Controller (2), the Signal Interpreter (5) also receives data from the Camera (3) and the Sensor Package (4). The Camera (3) can exist in various forms, including a freestanding camera, or one incorporated into the monitor, such as a webcam. The Sensor Package (4) includes sensors related biofeedback, including but not limited to a heart rate monitor, galvanic skin response, a brain wave monitor, or an electromyography signal, or combinations thereof. The Sensor Package (4) also includes sensors related to the kinematics and kinetics of the participant, including but not limited to accelerometers and strain gauges. The Sensor Package (4) can exist in many forms, examples of which would include sensors worn by the participant, in a manner similar to a wristwatch, or sensors contained within the Exercise Controller (1) or Complementary Controller (2), or through video motion caption systems. An example of a purpose of the additional data collected by the Camera (3) and/or Sensor Package (4) would be to ensure exercise compliance as prescribed by a healthcare provider (29).

The data from the Exercise Controller (1), Complementary Controller (2), Camera (3) and Sensor Package (4), is stored by the Data Storage (9), which contains the necessary hardware and software to store data. This data is transmitted to a remote location, the Remote Processor (22), by the Data Transmitter (10) to the Remote Processor Data Receiver (11), either over the internet or by other means. This transfer of data will be done in a secure manner. The transfer of data can be done either in real time or at a later time. Data can also be gathered without connection to the Remote Processor (22). This would be accomplished by downloading the data through the Local Data Retrieval Mechanism (26). An example of how this would function would be the participant, downloading the data from the Processor (21) to an SD card. This data could then later be used by the therapist in order to give feedback and update the prescription. This allows the system to function if there is no connection to the Remote Processor.

The Remote Processor (22) can exist in several forms, including but not limited to a processor utilized by the therapist, or an automated processor system. The data received by the Remote Processor Data Receiver (11) is then stored by the Remote Processor Data Storage (12), for use in both real time and later analysis, either on the individual participant, or on mass groups of participants. The data is then utilized by the Data Analyzer (13). The Data Analyzer (13) can exist in many forms. One is an automated system which interprets the data on the use of the system in order to determine information on the participant. Another could be a manual system where the rehabilitation therapist views the data and classifies the participant's use of the system and progress manually. Once the data is analyzed by the Data Analyzer (13), the prescription for the participant, is updated by the Prescription Updater (14). The Prescription Updater (14) can exist as an automated system or a manual system, which would be utilized by the therapist. The purpose of the Prescription Updater (14) is to utilize information on the participant's use of the system and their progress, and determine a new prescription or other feedback for the participant, to use in order to advance in their healing. An example of a new prescription could be for the participant, to use the system for an extra hour each week, and an example of other feedback would be positive reinforcement based on the use of the system. The new prescription or feedback is then transferred back to the Processor (21) by means of the Remote Processor Data Transmitter (15).

The new prescription or feedback is received from the Remote Processor Data Transmitter (15) by the Information Receiver (16). The new prescription will update the Prescription Information Storage (24). The new prescription can also be updated locally through the Local Prescription Input (25). The Local Prescription Input (25) could exist in many forms, one example of which would be an SD card reader, with the prescription being given to the participant, on an SD card and uploaded into the Processor (21) locally. This allows the system to function without connection to the Remote Processor (22). The information from the Prescription Information Storage (24) is analyzed by the Prescription Analyzer (27). The Prescription Analyzer (27) also receives information from the Real Time Data Analyzer (17) and the Data Storage (9). The Prescription Analyzer (27) compares the use of the system, through the data in the Data Storage (9) and the analysis done by the Real Time Data Analyzer (17), with the prescription that is stored in the Prescription Information Storage (24). This is for the purpose of giving feedback to the participant, on the proper use of the system. An example of how the Prescription Analyzer (27) would function would be if the prescription from the therapist called for a certain number of repetitions of a rehabilitation motion using the Exercise Controller (1), and once the participant, achieved that number of repetitions, feedback would be given to the participant, through the Feedback Mechanism (18) stating that the exercise was complete.

The new prescription or feedback is given to participant, by means of the Feedback Mechanism (18). The Feedback Mechanism (18) outputs in a variety of ways. One example way would be by posting a new prescription on the Monitor (8) for the participant, to see. Another would be by giving feedback to the participant, through the Feedback Device (19). The Feedback Device (19) can exist in various forms, including speakers for auditory feedback, a mechanical or electrical device for haptic feedback, or other forms. The Feedback Device (19) can be a freestanding device, or a component of either the Exercise Controller (1) or the Complementary Controller (2).

The Feedback Mechanism (18) is capable of giving feedback to the participant, based on analysis of data over periods of time, such as a new prescription, or in real time. Real time feedback would be given based on data analyzed by the Real Time Data Analyzer (17), which takes information from the Signal Interpreter (5) and uses it in real time in order to give live feedback to the participant. Alternatively, feedback could be given by a technician monitoring system use. Real time feedback would be given for various reasons. One would be for proper compliance with the rehabilitation regimen. The proper compliance is determined in several ways. The primary method is by utilizing data from the Camera (3), which is then interpreted by the Processor (21) through the Signal Interpreter (5), and then analyzed by the Real Time Information Analyzer (17). Various metrics would be analyze by the Real Time Information Analyzer (17), including whether the participant, is maintaining proper posture, which is desirable for successful implementation of rehabilitation routines. The Real Time Information Analyzer (17) also analyzes information from the Exercise Controller (1) as well as Sensor Package (4). The Real Time Information Analyzer (17) is able to give real time feedback through the Feedback Mechanism (18). The feedback is given to the participant, in a variety of forms. This includes visual feedback on the Monitor (8) auditory feedback, or other feedback through the Feedback Device (19). An example of real time feedback based on the Camera (3) would be a buzzer that sounds if the participant, fails to maintain proper posture during use of the system. An example of real time feedback based on the Sensor Package (4) would be if the heart rate of the participant, became too high, a sound would notify the participant, to take a break in their exercise. Further, if an undesirable level of error occurred a time out could be enforced.

One example of determining proper compliance and giving feedback is to use a set of switches (mechanical switches or capacitors) as Sensor Package (4). This kind of Sensor Package (4) can be placed against or near the exercise limb or body part to be treated by the system and method of the invention. The participant, is encouraged to maintain a good posture by contacting or pressing the switches. The data received by the Sensor Package (4) is transmitted to Signal Interpreter (5) and stored in the Data Storage (9). The data will be analyzed real time during the game-play by the Real-time Data Analyzer (17). If bad posture occurs during game-play, the Real-time Data Analyzer (17) will give feedback through Feedback Mechanism (18), in this example, an auditory reminder. For example, a participant, is prescribed to exercise wrist extension and flexion. During game-play, instead of using the targeted joint, a participant, moves their elbow by elevating their forearm. A set of switches will capture this error in movement and the system will give auditory feedback saying, for example, “Put your arm back to the arm rest.”

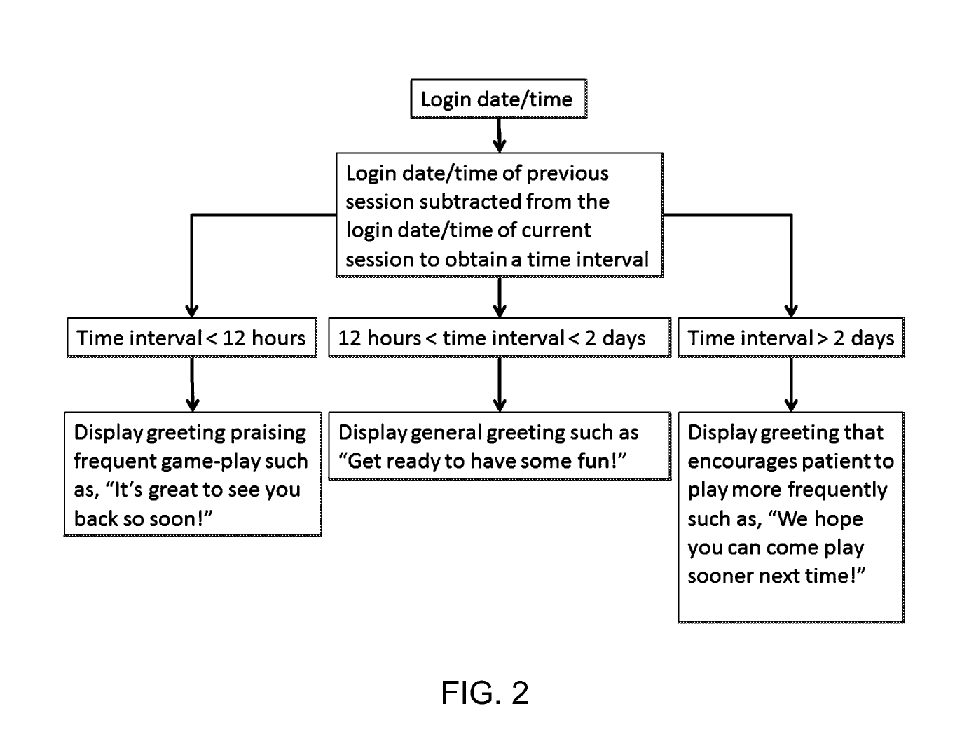

Another example of a feedback mechanism is improved program adherence. The log-in time and log-out of each session, as well as other aspects of usage patterns, will be recorded and stored in Information Storage (24). The comparison between the current log-in time and previous log-in time will be carried out by the Real-time Data Analyzer (17) and a corresponding greeting will be given according to the time lapse or usage pattern. FIG. 2 depicts an algorithm for selecting greetings from the language pools according to one embodiment of the invention.

Along with the use of the Exercise Controller (1), the system can also include other methods of rehabilitation for the participant. The Secondary Rehabilitation Mechanism (31) can exist in various forms, including but not limited to DC Stimulation of nerves, muscles or the brain, pharmacological agents, or other mechanisms which aid in rehabilitation.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method for therapeutically motivating a participant, lacking at least partial body or extremity motor control, comprising the steps of:
a) prescribing an individual rehabilitation exercise program for the participant, that includes at least one of sensory stimulation, motor stimulation and motor facilitation, by manipulating at least one programmed response of an exercise controller;
b) sending a signal generated by the exercise controller to a video console and video monitor by way of a secondary processor, in response to manipulation of the exercise controller by the participant by use of a first body part of the participant;
c) sending a signal that is complementary to the signal generated by the exercise controller, to the video console by way of the secondary processor, the complementary signal being generated by a complementary controller also manipulated the participant by using a second body part of the participant;
d) modifying at least one said programmed response of the exercise controller consequent to a comparison of the signal generated by the exercise controller to the rehabilitation exercise prescription; and
e) sending a signal generated by the modified program response from the secondary processor to at least one of an audio, visual, proprioceptive and tactile indicator that is linked to at least one of the video console and the secondary processor, thereby tailoring the signal of the exercise controller and, consequently, therapeutically motivating the participant.

2. The method of claim 1, further including generating a signal from the secondary processor to a remote processor, wherein the programmed response is modified in response to at least one of: the signal generated by the exercise controller; changes in the rehabilitation exercise prescription; and the comparison made between the signal generated by the exercise controller and the rehabilitation exercise prescription.

3. The method of claim 2, wherein the rehabilitation exercise prescription is generated, at least in part, by a monitoring sensor that monitors the manipulation of the exercise controller by the participant, and modulates the reference standard.

4. The method of claim 3, wherein the monitoring sensor includes at least one of a sensor package and a camera that is linked to the secondary processor.

5. The method of claim 4, further including the step of monitoring at least one physical condition of the participant.

6. The method of claim 5, wherein the physical condition of the participant is at least one member of the group consisting of heart rate, respiratory rate, galvanic skin response, temperature, brain waves, electromyography signals, eye position and pupillary diameter.

7. The method of claim 6, wherein the modified program response is modulated, at least in part, by the physical condition of the participant.

8. An apparatus for therapeutically motivating a person lacking at least partial body or extremity motor control, comprising:
a) an exercise controller that responds to therapeutic motions of at least one extremity of the participant;
b) a video console;
c) at least one of an audio, visual, proprioceptive and tactile indicator, linked to the video console; and
d) a secondary processor linking the exercise controller and the video console, whereby the secondary processor can modify signals from the exercise controller so that a programmed response of the video console to the exercise controller can be modified in response to a comparison with a rehabilitation exercise prescription in an updating manner to motivate the patient to employ therapeutic motions of the extremity to thereby obtain a desired response by the video console; and
e) a complementary controller that is linked to the secondary processor that sends at least one signal that is complementary to the signal generated by the exercise controller.

9. The apparatus of claim 8, further including a remote processor linked to the secondary processor, whereby the programmed response can be modified in response to at least one of signal generated by the exercise controller, changes in the rehabilitation exercise prescription and the comparison made between the signal generated by the exercise controller and the rehabilitation exercise prescription.

10. The apparatus of claim 9, wherein the indicator is a video monitor screen.

11. The apparatus of claim 10, further including at least one of a sensor package and a camera linked to the secondary processor that is linked to the secondary processor and modulates the secondary processor.

12. The apparatus of claim 11, wherein the sensor includes a body sensor linked to the secondary processor.

13. The apparatus of claim 12, wherein the body sensor is at least one sensor selected from the group consisting of a heart rate sensor, a respiratory rate sensor, a galvanic skin response sensor, a temperature sensor, a brainwave sensor, an electromyography sensor, an eye position sensor and a pupillary diameter sensor.
